(19) United States
(12) Patent Application Publication
(10) Pub. No.: US 2023/0264525 A1
(43) Pub. Date: Aug. 24, 2023

(54) SYSTEM FOR SETTING STORING POSITIONS OF TIRES AND METHOD FOR THE SAME

(71) Applicant: Orange Electronic Co., Ltd, TAICHUNG CITY (TW)

(72) Inventors: HUNG-CHIH YU, TAICHUNG CITY (TW); JIAN-ZHI WANG, TAICHUNG CITY (TW); MING-YUNG HUANG, TAICHUNG CITY (TW)

(21) Appl. No.: 18/074,157

(22) Filed: Dec. 2, 2022

(30) Foreign Application Priority Data
Feb. 22, 2022 (TW) 111106391
Aug. 10, 2022 (TW) 111129991

(51) Int. Cl. B60C 23/04

(52) U.S. Cl. CPC B60C 23/0416; B60C 23/0479

(57) ABSTRACT

A method for storing positions of tires and a system for the same are disclosed. The method includes inputting information for a tire by a hand held tool. Transmitting the information for the tire and a storing position of the tire to a remote server, and generating an index information including the storing position of the tire by the remote server. Accordingly, the storing position of the tire can be conveniently inquired, such that the time-consuming of changing the tires of vehicle can be effectively reduced.

### RELATED APPLICATIONS

This application claims priority to Taiwan Application Serial Number 111106391 filed on Feb. 22, 2022, and 111129991 filed on Aug. 10, 2022, which are herein incorporated by reference.

### BACKGROUND

### Technical Field

The present disclosure relates to a method and a system for setting storing positions of tires, and in particular to a method for setting storing positions of tires with a hand held tool.

### Description of Related Art

A tire is the most important component of a vehicle since it directly contacts the ground during the vehicle traveling. Generally, types of tires corresponding to seasons includes summer tire fitting with summer, winter tire fitting with winter, and all-season tire. For a driver who concerns driving safety or states in a country where has a clear reversal of season, to change different types of tires for different seasons is necessary. For a vehicle maintain plant or a tire plant, how to manage different tires of different customers needs a convenient and effective way to save the time for searching for specific tires of a specific customer. Particularly, the changed tires by the vehicle maintain plant or the tire plant are stored in a tire hotel, and the tire hotel stores a mass number of tires. To search for a specific tire from a mass number of tire is time-consuming and laborious. Therefore, to provide a method for quickly searching for a storing position of a tire for saving the time of changing tires is needed.

To overcome the shortcomings, the present invention tends to provide a method and a system for setting storing positions of tires to mitigate or obviate the aforementioned problems.

### SUMMARY

The main objective of the invention is to provide a method and a system for setting storing positions of tires including a hand held tool. Information for a tire can be inputted into the hand held tool by hand-inputting, scanning, or picturing and is sent to a remote server by the hand held tool. Accordingly, a tire seller or a tire manufacturer can conveniently get the storing position of the tire from the remote server. Thus, to store and take a tire is time-saving.

The present invention provides a system for setting a storing position of a tire comprising:
a hand held tool for inputting a basic information for the tire and a storing position of the tire in a tire hotel and at least comprising:
   a first circuit board; and
   a first chip module mounted on the first circuit board and electrically to and controlling a power module, a memory, an operation module, and a network communication module for sending the basic information and the storing position of the tire; and
a remote server for receiving the basic information and the storing position of the tire sent from the hand held tool, wherein one of the hand held tool and the remote server generates an index information including the basic information and the storing position of the tire.

The present invention also provides a method for setting a storing position of a tire comprising steps of:
inputting a basic information of a tire by a hand held tool;
inputting a storing position of a tire in a tire hotel by the hand held tool; and
transmitting the basic information of the tire and the storing position of the tire to a remote server from the hand held tool, and generating an index information by one of the hand held tool and the remote server.

The present invention further provides an electronic device having a program for setting a storing position of a tire comprising:
providing a selection interface means for providing a selection interface for entering a booking interface, customer information interface or a tire information searching interface;
inputting basic information means for inputting the basic information of the tire from an inputting interface;
inputting storing position means for inputting a storing position of the tire in a tire hotel from an inputting interface; and
transmitting means for transmitting the basic information of the tire and the storing position of the tire to a remote server.

The present invention further provides an electronic device having a program for gaining a storing position of a tire comprising:
inputting means for inputting a basic information of the tire and storing the basic information of the tire in a memory of the electronic device; and
transmitting means for transmitting the basic information of the tire to a remote server, wherein an index information including the basic information of the tire is stored in the remote server is transmitted to the electronic device, thereby a storing position of tire in a tire hotel is capable of being get by the index information or directly get from the memory of the electronic device.

The present invention further provides a method for searching for a storing position of a tire in a tire hotel comprising steps of:
inputting a basic information of a tire by a hand held tool and transmitting the basic information of the tire to a remote server; and
searching for an index information including a storing position of the tire in a tire hotel corresponding to the sent basic information of the tire, transmitting the index information to the hand held tool, and search and show the storing position of the tire on the hand held tool by using the index information.

### BRIEF DESCRIPTION OF THE DRAWINGS

The disclosure can be more fully understood by reading the following detailed description of the embodiment, with reference made to the accompanying drawings as follows:

FIG. 1 is a block diagram of a vehicle tire management system for a system for setting a storing position of a tire in accordance with the present invention;

FIG. 2 is a block diagram of an embodiment of a hand held tool of the system in FIG. 1;

FIG. 3 is a perspective view of an embodiment of the hand held tool in FIG. 2;

FIG. 4 is a schematic diagram showing a basic information being inputted into the hand held tool in FIG. 3;

FIG. 5 is a block diagram of a TPNS sensor for the system in FIG. 1;

FIG. 6 is a block diagram of an embodiment of a method for setting a storing position of a tire in accordance with the present invention;

FIG. 7 is a block diagram of a first embodiment of a system for setting a storing position of a tire in accordance with the present invention;

FIG. 8 a block diagram of a second embodiment of a system for setting a storing position of a tire in accordance with the present invention;

FIG. 9 is a block diagram of another embodiment of a method for setting a storing position of a tire in accordance with the present invention;

FIG. 10 is a schematic diagram showing an operation interface for searching for a storing position of a tire from the remote server in FIG. 1;

FIG. 11 is an operational schematic diagram showing data being read from or written into an RFID in accordance with the present invention;

FIG. 12 is a schematic diagram of a third embodiment of a system for setting a storing position of a tire in accordance with the present invention'

FIG. 13 a front view of a TPMS activating device for the system in accordance with the present invention;

FIG. 14 is a block diagram of an embodiment of the TPMS activating device in FIG. 13;

FIG. 15 is a block diagram of an application program for the system in accordance with the present invention; and

FIG. 16 to FIG. 20 show multiple interfaces for the application program in FIG. 15.

### DETAILED DESCRIPTION

The following is the description of the present disclosure according the drawings. For describing precisely, the details in practice will be introduced as below, but the details should not be a limitation of the present disclosure. Namely, the details introduced in the specification are optional. Moreover, for simplifying the drawings, the conventional structures or members will be shown briefly therein, and the repeated members will be labeled as the same number.

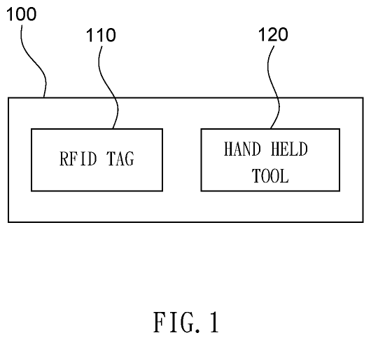

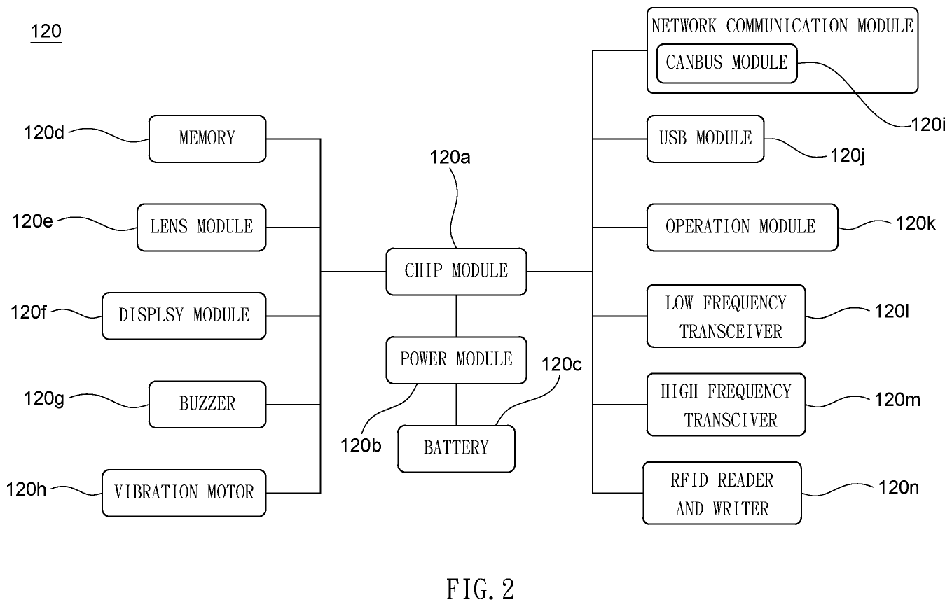

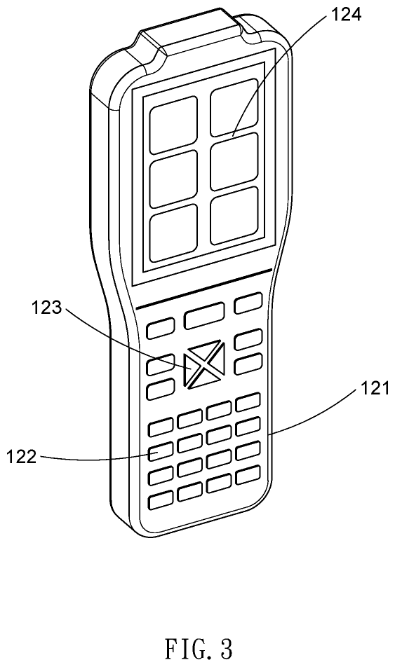

With reference to FIGS. 1 to 4, FIG. 1 shows a vehicle tire management system 100 in accordance with the present invention, FIG. 2 shows a block diagram of an embodiment of a hand held tool 120 in FIG. 1, and FIG. 3 shows a perspective view of an embodiment of the hand held tool 120 in FIG. 2.

IN FIG. 1, the vehicle tire management system 100 comprises a radio frequency identification tag (RFID) and a hand held tool 120. The RFID can store information of a tire. in FIG. 2, the hand held tool 120 is a tool that can be held by a user and may be an individual part for a vehicle, and can be carried by a user to be used at any desired position. Preferably, the hand held tool may be a TPMS setting tool as shown in FIG. 3. The hand held tool 120 comprises a circuit board and a chip module 120a mounted on the circuit board. The chip module 120a is a control center and is electrically connected with and controls a power module 120b, a memory 120d, a lens module 120e, a display module 120f, a buzzer 120g, a vibration motor 120h, a network communication module, a USB module 120j, an operation module 120k, a low frequency (125 KHz) transceiver 1201, a high frequency (315MH/433MH) transceiver 120m, and an RFID reader and writer 120n. The network communication module may be a wire network module, such as a controller area network (CANBUS) module 120i as shown in FIG. 2 or a wireless network module, such as 4G, 5G, or WI-FI.

The chip module 120a has a logical operation functionality, and a wireless communication chip is integrated in the chip module 120a in order to exchange data with another devices through various communication protocols (e.g., Wi-Fi, Bluetooth, etc.). For example, data can be exchanged with a remote server through a Wi-Fi communication protocol, or a mobile phone through a Bluetooth communication protocol

The power module 120b provides required power to operate the hardware. In one example, a battery 120c can be used as a power source, but not limited thereto.

The memory 120d can store data, and a software program can be loaded therein for processing the vehicle service message and the operation message for the tire. the vehicle service message may comprise a name of a buyer of a tire, a name of a seller of a tire, an address of a buyer of a tire, an address of a seller of a tire, and an ID of a tire. the operation message may comprise but is not limited to a tire pressure, a tire temperature, an electricity of a TPMS sensor, and an ID of a TPMS sensor.

The lens module 120e can include lenses for scanning or taking a picture of a Bar code, a QR code or a number on a tire skin that may be an ID of a tire. After the lens module 120e scan or picture of the ID of the tire, a photo is outputted to the chip module 120a. The photo is then recognized through an image processing software for obtaining the tire ID. At this time, a tire buyer name, a tire seller name, a tire buyer address and a tire seller address can be inputted through the operation module 120k or the display module 120f, can be associated with the tire ID to a file, and then the file can be saved to the memory 120d or can be transmitted to a remote server 140 from the chip module 120a. Furthermore, the tire ID, the tire buyer name, the tire seller name, the tire buyer address and the tire seller address can be directly transmitted to the remote server 140 from the hand held tool 120 after being obtained through the hand held tool 120. These data can be associated to generate an association data. When a tire seller or a tire manufacturer obtains the association data through the remote server 140, the location of the tire can be obtained. After a period of time, the file or the association data can be used for recycling the tire if required.

The display module 120f can include a touch input interface. The vehicle message, the tire message and the vehicle service message can be inputted through the touch input interface. The vehicle message may comprise a name of a vehicle owner, an address of a vehicle owner, model of the vehicle, or a license plate number. The tire message may include model, size and setting position of the tire.

The low frequency (125 KHz) transceiver 1201 can transmit a triggering signal to the TPMS sensor 160. The TPMS sensor 160 transmits back the operation message or the vehicle service message after receiving the triggering signal.

The high frequency (315 MHz/433 MHz) transceiver 120m can receive the operation message, and can process the operation message and the vehicle service message through the software program stored in the memory 120d. The chip module 120a executes an instruction of the software program. The instruction includes: generating a user profile for storing the operation message and the vehicle service message; transmitting the operation message and the vehicle service message to a remote server through the chip module 120a, and transmitting the vehicle service message.

The vehicle message can be transmitted to a remote server from the chip module 120a.

The aforementioned CANBUS module 120i can be applied to be connected with a receiving device 150 of a computer of the vehicle. The receiving device 150 is mounted in the computer of the vehicle or can be an individual part connected with the vehicle computer by wireless or wire, such as a cigar lighter.

The USB module 120j can be used to connect with a mobile phone or a computer.

The operation module 120k can make a functional confirmation through an operation of a button or a knob and can be applied to input the vehicle service message and the basic information.

The buzzer 120g and the vibration motor 120h can generate warning sound or vibration while an error occurring.

The RFID reader and writer 120m is applied to read data stored in the RFID tag 110 or write data into the RFID tag 110, the RFID can be built in or be connected with the hand held tool 120.

The hand held tool 120 may have a slot. An additional memory (e.g. a SD card) can be inserted into the slot to save vehicle service message and the operation message.

The RFID tag 110 (radio frequency identification tag, RFID tag) saves a basic information of a tire, such as a manufacturer of the tire, ID of the tire, model, size, or manufacturing data of the tire, or a name of a vehicle owner. In addition, another data, such as telephone number or email of the vehicle owner or a mounting position of the tire on the vehicle, such as left front wheel, left rear wheel, right front wheel, or right real wheel can be transmitted to the RFID tag 110 from the hand held tool 120.

In an embodiment, the RFID tag 110 can be directly attached to the tire skin of the tire. in another embodiment, the RFID tag 110 can be integrated in a TPMS sensor (tire pressure monitoring system sensor). The TPMS sensor can monitor an operational status of the tire, can generate an operation message, and send the operation message outward.

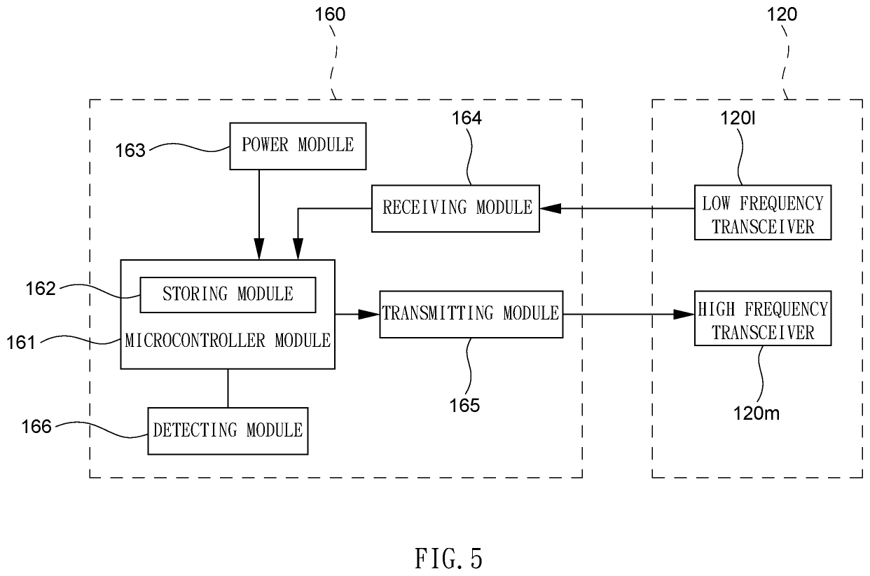

With reference to FIG. 5, the TPMS sensor 160 comprises a storing module 162 and a receiving module 164. The storing module 162 can save the operation message. The receiving module 164 is electrically connected with the storing module 162 and can receive the vehicle service message to save the vehicle service message in the storing module 162. The TPMS may further comprise a microcontroller module 161, an electricity module 163, a transmitting module 165, and a detecting module 166. The electricity module 163, the transmitting module 165, and the detecting module 166 are all electrically connected with the microcontroller module 161.

FIG. 3 shows an appearance of a real product of the hand held tool 120. The hand held tool 120 includes a handle 121, a button 122 (can be a confirmation button or a return button), a function selection button 123, and a touch input interface 124. The function of the button 122 and the function selection button 123 can be varied with different software. A connection port can be applied to connect with a mobile phone or a computer. A slot can be applied to be inserted with an additional memory (e.g. a SD card). A button can be applied to confirm the function selection. It should be known that the real product structure of the hand held tool 120 is not limited within that disclosed in the disclosure, another kind of structure can possibly be constructed.

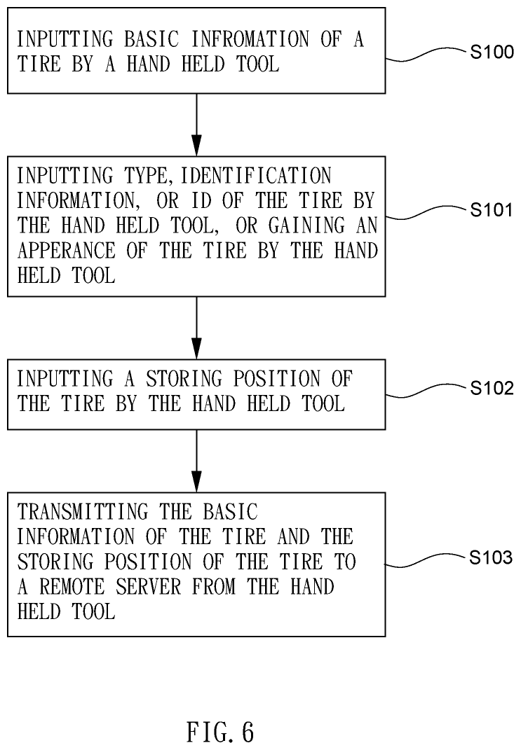

With reference to FIG. 6, FIG. 6 shows a block diagram of a method for setting a storing position of a tire. The method for setting a storing position of a tire in accordance with the present invention comprise steps of step S100 of inputting a basic information of a tire by a hand held tool, step S102 of inputting a storing position of a tire in a tire hotel by the hand held tool, step S103 of transmitting the basic information of the tire and the storing position of the tire to a remote server. Wherein, the basic information of a tire may comprise one of a tire message, a vehicle message, or information of a vehicle owner. The tire message may include a manufacturer of the tire, ID of the tire, or model, size, or manufacturing date of the tire. The vehicle message may include a license plate number of a vehicle on which the tire is mounted or an identification number of the vehicle. The message of a vehicle owner is a message to identify the vehicle owner may include a vehicle owner's name, telephone number or email. In addition, the storing position can be inputted first, and the basic information of the tire is then inputted. That is the step S102 is processed first, and the step S100 is then processed. How the aforementioned tire management system works is shown in follows.

The storing position of the tire in the tire hotel means that an actual position where the tire is stored in the tire hotel. For example, the tire is stored in a position on a specific shelf in the tire hotel. The storing position does not mean a position where the tire is mounted on a vehicle, such as a left front wheel, a left rear wheel, a right front wheel, or a right rear wheel, does not mean a position of a spare tire on a vehicle, and even does not mean a location or an address of the tire hotel. The lens module on the hand held tool scans a bar code on a tire cannot gain the storing position of the tire in the tire hotel, because the storing position of the tire in the tire hotel is not stored in the bar code of the tire. the storing position of the tire in the tire hotel has to be inputted manually or hand-operatedly into the hand held tool. The storing position of the tire can be stored in the memory module of the hand held tool or the remote server.

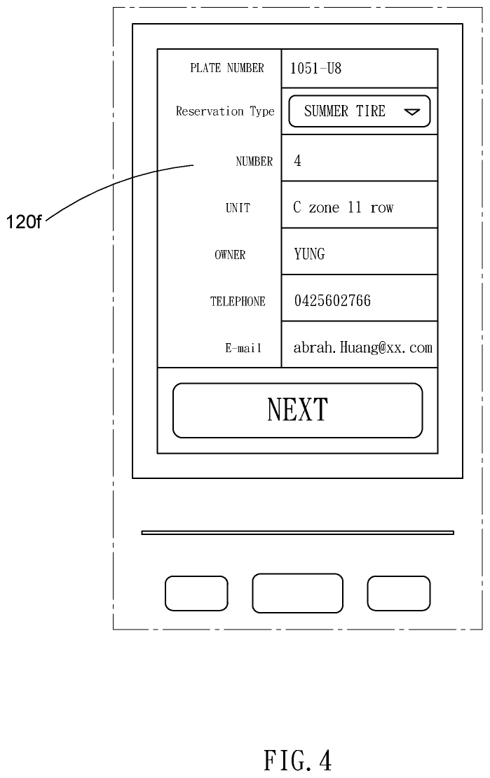

With reference to FIGS. 2 and 4, when a basic information is inputted into the hand held tool 120, the license plate number of the vehicle, vehicle identification number, or vehicle owner information, such as name or telephone number f the vehicle owner can be directly inputted into the hand held tool 120 by the display module 120f or the operation module 120k. Alternatively, the RFID reader and writer 120n on the hand held tool 120 can be applied to read the tire message stored in the RFID tag 110 attached on the tire, or the lens module 120e on the hand held tool 120 can be applied to gain words on the tire, such as ID or model of the tire to input the basic information. The way of the lens module 120e for gaining words on the tire may be scanning or picturing.

In addition, after the basic information of the tire is inputted, the step S101 can be processed again. In the step S101, the type of the tire, such as winter tire, summer tire or all season tire, the storing number of tires, department of transportation (DOT) of the tire, or ID of the tire can be inputted into the hand held tool 120. The mounting position of the tire on the vehicle, such as the left rear wheel position, left front wheel position, right front wheel position, or right rear wheel position can also be inputted into the hand held tool 120 to confirm the mounting position of the stored tire on the vehicle. The lens module 120e on the hand held tool 120 can picture the appearance of the tire, to ensure that whether the tire has any flaw or not. The status of the appearance of the tire can be stored in the remote server 140 to prevent a dispute about any damage on the tire. the number of the tires, the identification information, ID of the tire and the pictures of the tire are also transmitted to the remote server 140.

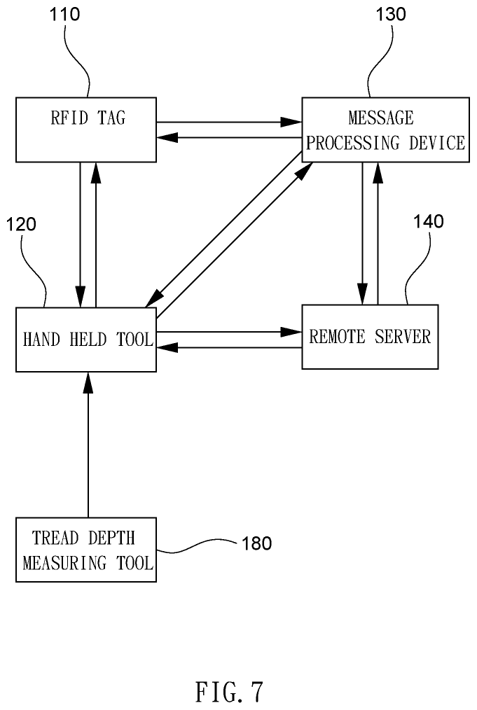

With further reference to FIG. 7, FIG. 7 shows a block diagram of an embodiment of a tire management system in accordance with the present invention.

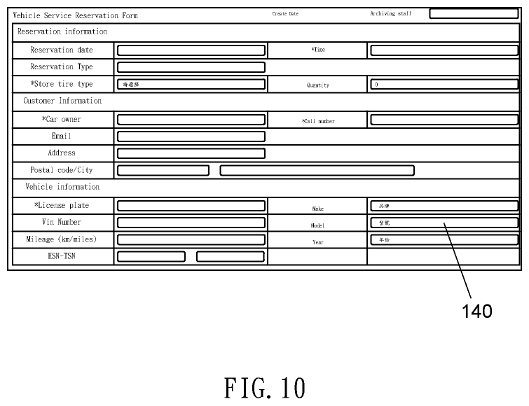

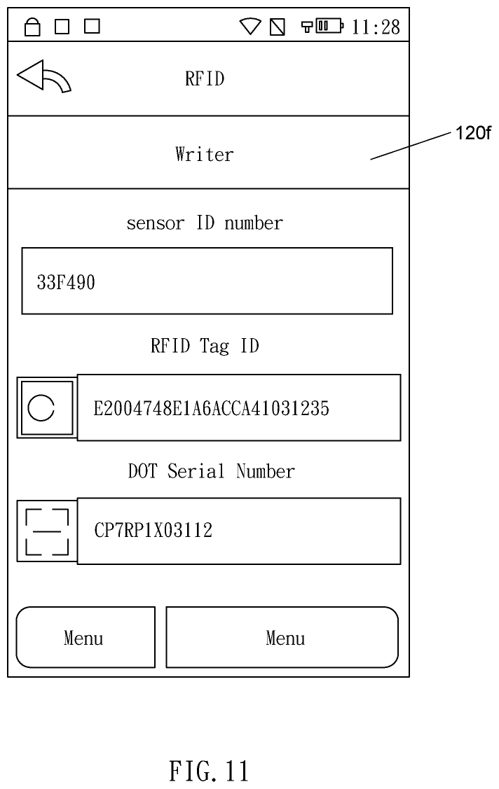

In FIG. 7, the tire management system in accordance with the present invention comprises an RFID tag 110, a hand held tool 120, a message processing device 130, and a remote server 140. The RFID tag 110 can store a tire message. The hand held tool 120 can read messages stored in the RFID tag 110 or another messages written and stored in the RFID tag 110, such as an ID of the RFID tag, ID of a corresponding TPMS sensor as shown in FIG. 11. The hand held tool 120 can receive an outer message, such as a mounting position of the tire, name of model of the vehicle, vehicle model, age of the vehicle, or number of the vehicle, can set up the storing position of the tire, and can send the relative messages, the storing position of the tire, and outer messages to the message processing device 130. These message can be transmitted to the remote server 140 from the message processing device 130 or directly from the hand held tool 120 as shown in FIG. 10. The remote server 140 generate and save an index information including the storing position of the tire.

The outer message received by the hand held tool 120 may include and be not limited to an ID of the hand held tool, an ID of the TPMS sensor, a tire traveling mileage, a tire pattern depth, a load, a tire ID, a tire brand, a tire model, a tire installation time, a tire installation location, an installation time and an installation location of the TPMS sensor, a tire installation factory location, a vehicle manufacturer name, a vehicle name, a vehicle model, a vehicle age, a vehicle number, a tire repairing factory location, a tire ID, a tire rim serial number, an employee number or ID of a maintenance staff, a tire storing position, a tire agent name, a tire reseller name, a tire agent address, a tire reseller address, a tire buyer name, a tire buyer address, a vehicle owner name, and a vehicle owner address. The communication protocol between the TPMS sensor 160 and the receiving device 150, a pressure of the tire, a size of the tire, a license plate number, a booking date or time for a vehicle owner arriving to the tire repairing factory, or error messages on the hand held tool or the message processing device can also be transmitted to the remote server 140. A system developer, such as a TPMS manufacture, can gain the error messages from the remote server 140 that can be an accordance or a reference for improving system or the remote server 140.

The operation messages and outer messages stored in the hand held tool 120 can be sent to the message processing device 130 or the remote server 140 by wire, such a network wire or wireless, such as WIFI, Bluetooth, 3G/4G/5G, or any possible wireless communication protocol. The message processing device 130 may be but be not limited to a mobile phone, a tablet, a notebook computer, or a desktop computer. The tire message and the outer message can be transmitted to and saved in the remote sever 140 from the message processing device 140 by wire or wireless. Therefore, the holder of the hand held tool 120 can regain the position message from the remote server 140 to get the storing position of the tire and another messages. Therefore, when a vehicle owner wants to change the tires, a basic information, including one of the license plate number, the vehicle identification number, the vehicle owner information, such as the name, telephone number, address, postal code, or staying city of the vehicle owner, the vehicle manufacturer, and the model or the manufacturing year of the vehicle can be inputted by the hand held tool 120. The basic information is then sent to the remote server 140, a corresponding index information is searched from the remote server 140 based on the basic information of the tire received by the remote server 140. Accordingly, the vehicle owner can conveniently search for the storing positions of the tires that are then transmitted back to the hand held tool 120. Thus, the tire repairing factory can conveniently get the desired tires for being changed. In addition, the vehicle owner can also input booking message for the tire repairing factory by the message processing device 130. Wherein, the booking message can be one of the aforementioned outer messages and can form as a reservation form number. The message processing device 130 transmits the reservation form number to the hand held tool 120 through the remote server 140. The staff of the tire repairing factory operates the hand held tool 120 to open the reservation form number to display the booking message and can know the reservation vehicle owner and information for the vehicle and tires.

In addition, a tread depth measuring tool 180 can be applied to measure a depth of a thread of the tire, and the measured depth of the thread of the tire can be sent to the hand held tool 120 and is then transmitted to the remote server 140.

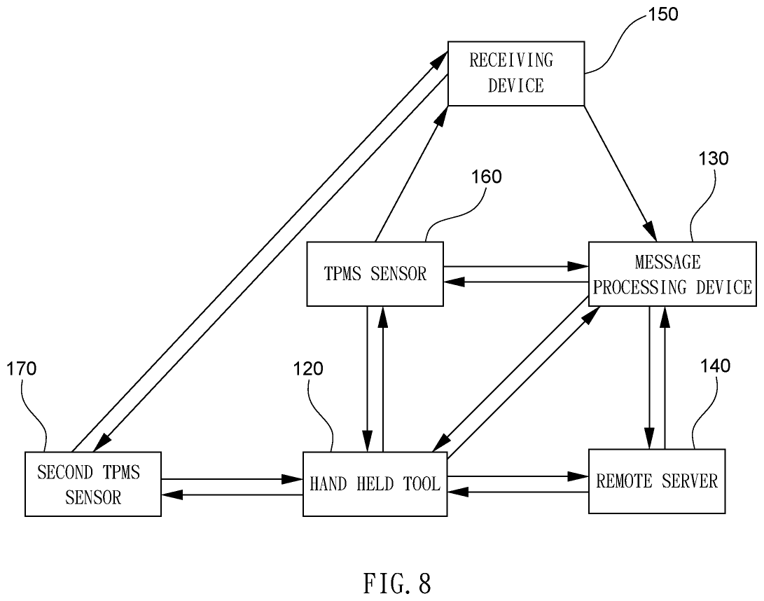

With reference to FIG. 8, in another embodiment of the tire management system in accordance with the present invention, an operation message of the TPMS sensor 160 can be received by a receiving device 150 that may be a vehicle computer or a tire pressure detecting machine for receiving the messages sent from the TPMS sensor 160. The operation message can be then sent to the message processing device 130 by a wireless channel and also can be transmitted to the remote server 140 for storage and analysis. The basic information and outer messages received by the hand held tool 120 can also be sent to the TPMS sensor 160 and be transmitted outward through the receiving device 150, or can be transmitted to the remote server 140 through the hand held tool 120. Finally, the remote server 140 contains operation message and outer message and can analyze and mate the operation message and the outer message, the analyzed and mated result can be sent to the message processing device 130 or the hand held tool 120. Accordingly, the holder of the message processing device 130 (mobile phone or computer) or hand held tool 120 can gain relative service message based on the transmitted analyzed and mated result.

One of or all of the maker, the model, and the year of the vehicle is inputted into the hand held tool 120, wherein the maker, model, and year is referred to as MMY. The hand held tool 120 choses an appropriate communication protocol from a database in the hand held tool 120. The communication protocol is sent to the TPMS sensor 160 and is programmed in the TPMS sensor 160, such that the TPMS sensor 160 can be in communication with the receiving device 150.

A triggering signal can be inputted into the hand held tool 120 and be sent to the RPMS sensor 160, and the TPMS sensor 160 responds the ID of the TPMS sensor 160 and the tire pressure of the corresponding tire to the hand held tool 120. The ID of the TPMS 160 can also be inputted into the hand held tool 120 by one of the display module and the operation module of the hand held tool 120. Additionally, after the hand held tool 120 receives the ID of the TPMS sensor 160 from the TPMS sensor 160 or be inputted with the ID of the TPMS sensor 160, the ID of the TPMS sensor 160 is then sent to a second TPMS sensor 170 from the hand held tool 120.

For example, each one of a winter tire and a summer tire respectively has a TPMS sensor 160, and each TPMS sensor has a different ID. If a summer tire is mounted on a vehicle and the ID of the TPMS sensor 160 on the summer tire is A01. The ID of A01 is also saved in the vehicle computer of the vehicle, such that the vehicle computer can recognize the TPMS sensor 160. When a winter tire with another TPMS sensor having a ID of A02 is exchanged with the summer tire, the vehicle computer only recognize A01. Therefore, the vehicle computer cannot be in communication with the TPMS sensor with the ID of A02. If the vehicle computer is capable of recognizing the ID of A02, the vehicle computer has to be reprogrammed. However, to reprogram the vehicle computer is complicated, so the ID of the TPMS sensor 160 on the summer tire has to be sent to the hand held tool 120, and be transmitted to the TPMS sensor on the winter tire by the hand held tool 120. Accordingly, the vehicle computer can recognize the ID of A02, and the TPMS can transmit messages to the vehicle computer without reprogramming the vehicle computer to save the time for reprogramming.

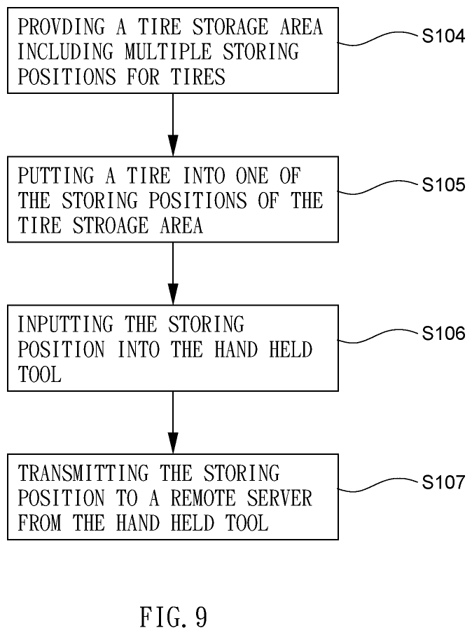

The RFID tag 110 in the present invention is attached onto the tire. The hand held tool 120 is held by a tire repairing factory, such as a vehicle maintenance plant or a tire seller. The message processing device 130 can also be arranged in the tire repairing factory, and the message processing device 130 may be a cell phone or desktop computer of the factory. In addition, the message processing device 130 may be a cell phone of a vehicle driver. Therefore, multiple application ways may be generated. For example, in winter, a summer tire is demounted and put on a shelf in the tire hotel. The hand held tool 120 scan the RFID tag 110 on the summer tire to gain the tire messages, and the storing position of the summer tire on the shelf are inputted into the hand held tool 120, e.g. third position of tenth row. The storing position is transmitted to the remote server 140, and an index information is generated and saved in the remote server 140. When the summer tire is needed, the basic information of the summer tire, such as the license plate number, vehicle message, vehicle owner message or MMY is inputted into the hand held tool 120, the storing position saved in the remote server 140 can be gained based on the basic information of the tire. Accordingly, the summer tire can be easily get and changed. With reference to FIG. 9, FIG. 9 shows a block diagram of a method for setting a storing position of a tire with the aforementioned tire management system 100. The method comprises steps of step S104 of providing a tire storage area, step S105 of putting a tire into one of storing positions of the tire storage area, step S106 of inputting the storing position into the hand held tool 120, step S107 of transmitting the storing position to the remote server 140 from the hand held tool 120. Wherein, the tire storage area comprises multiple storing positions for tires. When a vehicle goes to a tire repairing factory, a basic information of a tire is inputted into the hand held tool 120, and the storing position of the tire can be quickly gained and the tire can be conveniently changed. In addition, the consequences of the steps S105, S106, and S107 can be exchanged, For example, the step S106 is processed first, the step S107 is processed second, and the step S105 is then processed. Alternately, the step S106 is processed first, the step S105 is processed second, and the step S107 is then processed.

The aforementioned displays an application ways of reading the message on the RFID tag 110 and to inputting the storing position of the tire by the hand held tool 120 in corporation with the remote server 140. Thus, the method and system for setting the storing position of the tire in accordance with the present invention can be in corporation with multiple various outer messages to provide the driver a whole and immediate message service.

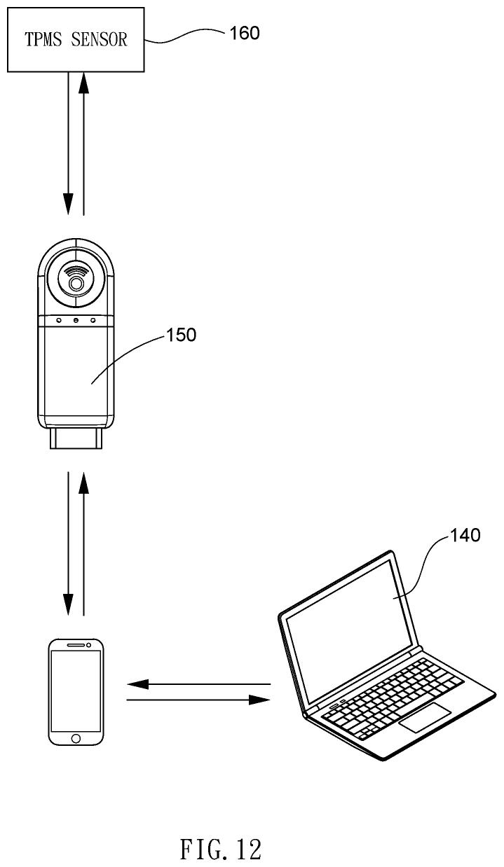

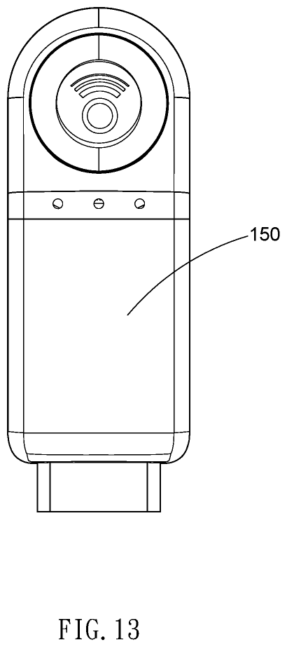

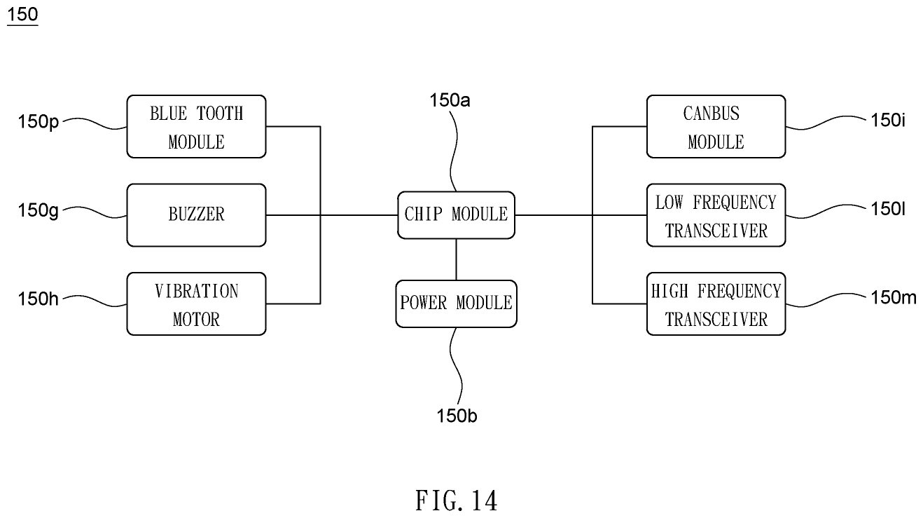

With reference to FIGS. 12 to 14, another embodiment of a hand held tool is shown. The hand held tool 150 may be a TPMS activating device 150. The TPMS activating device 150 comprises a circuit board and a chip module 150a mounted on the circuit board. The chip module 150a is electrically connected with and controlling a power module 150b, a blue tooth module 150p, a low frequency (125 KHz) transceiver 1501, a high frequency (315MH/433MH) transceiver 150m, and an operational knob. The high frequency transceiver 150m is capable of receiving a tire pressure signal sent from a TPMS sensor. The tire pressure signal includes a ID number of the TPMS sensor. The blue tooth module 120p is applied to connect with a mobile phone to transmit the tire pressure signal to the mobile phone. The operational knob is pressed to make the low frequency transceiver send a low frequency triggering signal to the TPMS sensor.

In addition, the TPMS activating device further comprises a buzzer 150g, a vibration motor 150h, and a controller area network (CANBUS) module 150i. the CANBUS module 1509 can be electrically connected with an on-board diagnostic (OBD) or a vehicle computer and can transmit the ID number of the TPMS sensor to the vehicle computer so as to save the ID number of the TPMS sensor in a memory of the vehicle computer or transmit an ID number of a TPMS to the TPMS activating device 150.

Accordingly, to connect the mobile phone with the blue tooth module 150p on the TPMS activating device 150, the TPMS activating device 150 can be controlled by a monitor of the mobile phone. The tire pressure signal in the TPMS sensor can be gained from the TPMS activating device 150 and is then sent to the mobile phone. The basic information of a tire, such as ID of the tire, name of the vehicle owner, license plate number, vehicle message, or MMY and a storing position of the tire in a tire hotel are then inputted into the mobile phone. The basic information and the storing position are then transmitted to the remote server 140. One of the mobile phone and the remote server 140 generates an index information including the basic information of the tire and the storing position of the tire, such that the processes of setting the storing position of the tire are finished.

If a user wants to change tires, the basic information of the tire is inputted by the mobile phone, and the storing position of the tire can be gained from the remote server 140 based on the basic information. Accordingly, the user can quickly gain the storing position of the tire and can conveniently get the tire from the tire hotel to change the tire for the vehicle owner.

In addition, the message processing device 130 may be an electronic device, such as a mobile phone or a notebook computer. With the electronic device, an application program for setting the storing position of a tire can be downloaded to the electronic device. A tire factory or a vehicle repairing factory holds the electronic device, and a TPMS sensor maker provides the application program. The basic information and the storing position of the tire can be inputted by the application program and are then sent to the remote server 140. When a user wants to take the stored tires, the basic information can be inputted by the application program in the electronic device. Thus, the storing position of the tire can be quickly searched in the remote server, and the tire can be taken and changed. In addition, when the basic information is inputted, the blue tooth module on the electronic device can be connected with a TPMS sensor 160, and a tire pressure signal in the TPMS sensor 160 is sent to the electronic device. The tire pressure signal includes an ID number of the TPMS sensor 160.

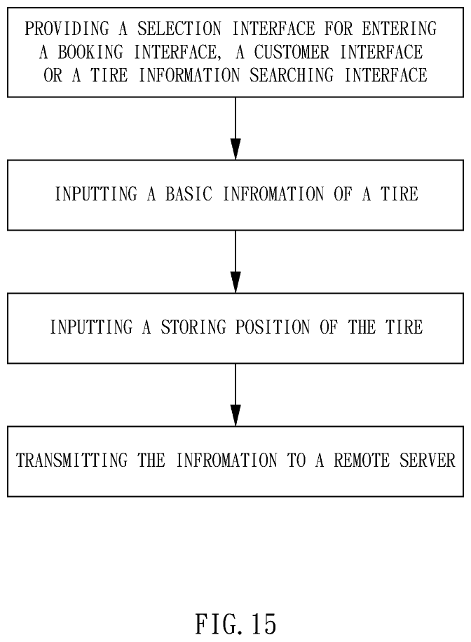

With reference to FIG. 15, the operation processes of the application program in the electronic device are shown as follows:

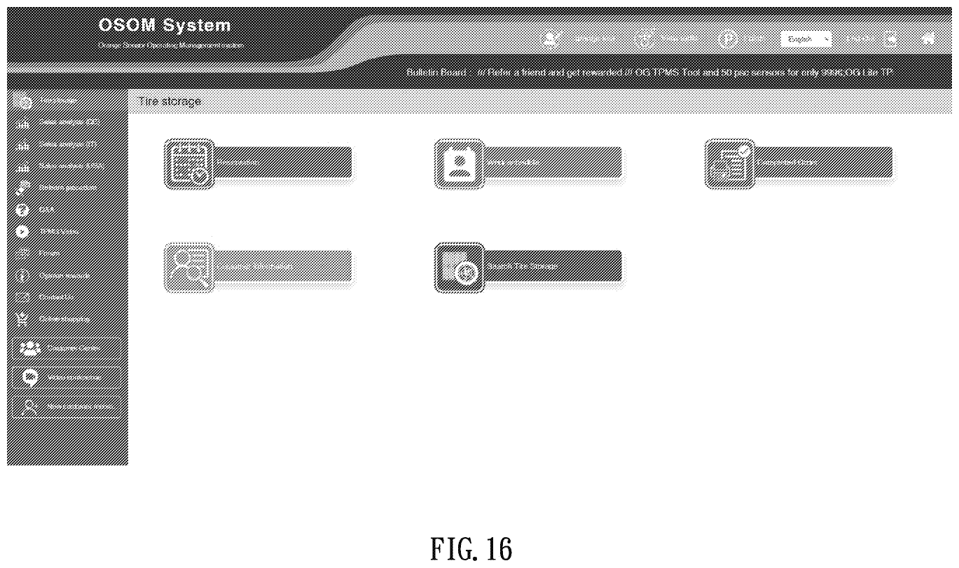

Providing a selection interface, as shown in FIG. 16. The selection interface is applied for entering a booking interface, a customer information interface, a work list interface, and tire-storage searching interface.

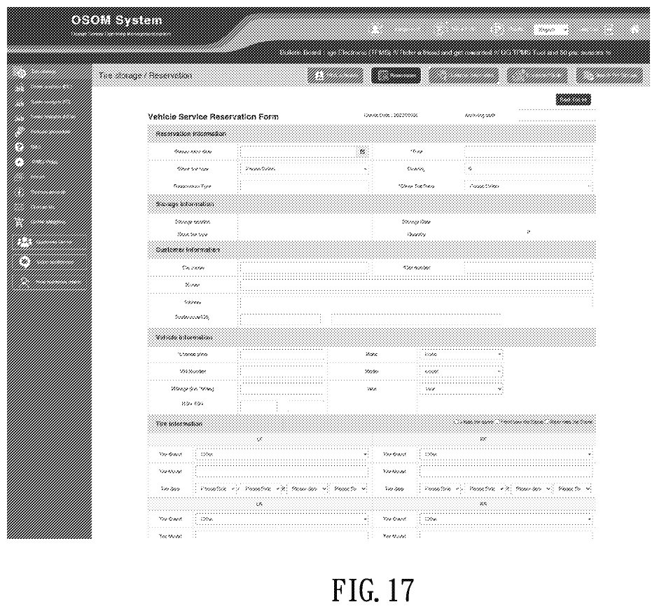

Inputting the basic information. When a reservation of a customer is gained, an inputting interface as shown in FIG. 17 can be entered from the booking interface, and the basic information of the tire, such as a license plate number, a vehicle identification number (VIN) or a vehicle owner message can be inputted by the inputting interface. If on reservation of a customer is gained, the inputting interface is directly entered, the basic information of the tire is inputted through the inputting interface. When the basic information is inputted, the brand and year of the vehicle or the name of the vehicle owner can be inputted first, a tire message, such as a brand, a model, or a size of the tire can be then inputted, and a department of transportation (DOT) and an ID of the tire can be inputted finally. Wherein, to input the ID of the tire can be done by key-in or scanning the appearance of the tire. in addition, a tread depth of the tire can be selectively inputted by measuring a tread depth of the tire by a tread depth measuring tool. The measuring result of the measuring tool can be sent to the mobile phone through the blue tooth module. Moreover, the appearance of the tire can be pictured by the mobile phone and be sent to the application program. In addition, an ID of a TPMS sensor, tire pressure, tire temperature, and electricity of the TPMS sensor can be read by a TPMS setting tool or a TPMS activating device, are sent to the mobile phone, and are inputted into fields of a table of the inputting interface.

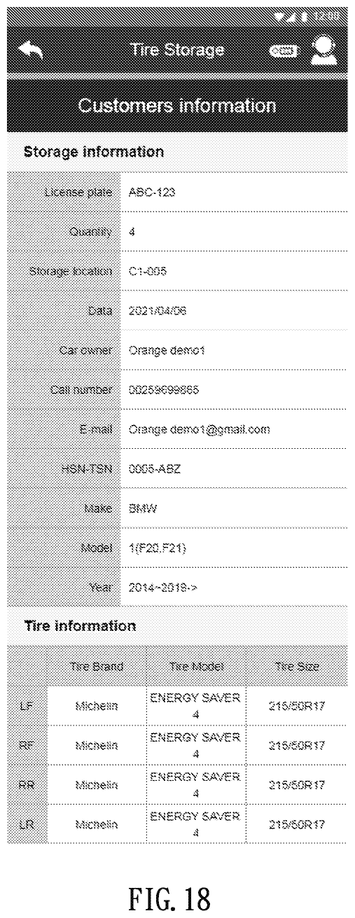

Inputting the storing position of the tire. The storing position of the tire in a tire hotel is inputted through the inputting interface, as shown in FIG. 18.

Transmitting the inputted information to a remote server. The basic information and the storing position of the tire are sent to and saved in the remote server. The application program in the electronic device generates an index information including the storing position of the tire and the basic information of the tire, and the index information is sent to the remote server. Alternately, the index information is generated by the remote server.

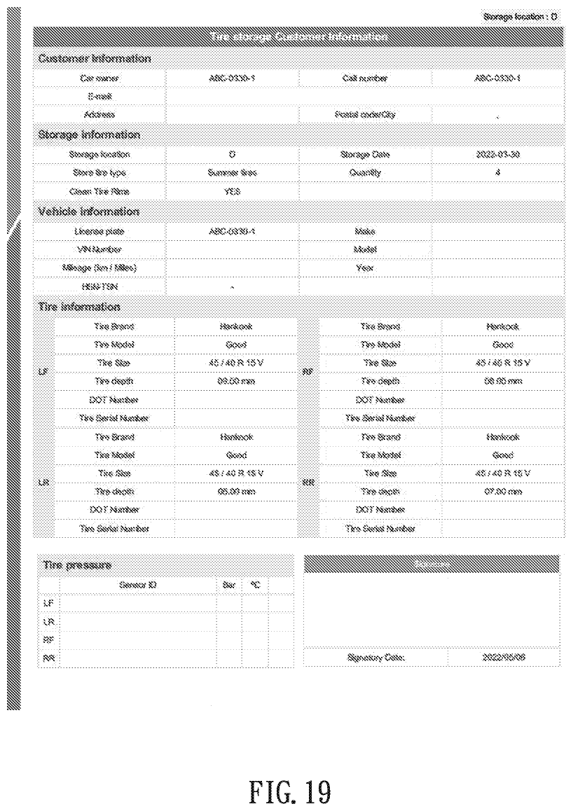

Printing the information. The basic information of the tire and the storing position of the tire can be selectively printed for the customer confirmation, as shown in FIG. 19.

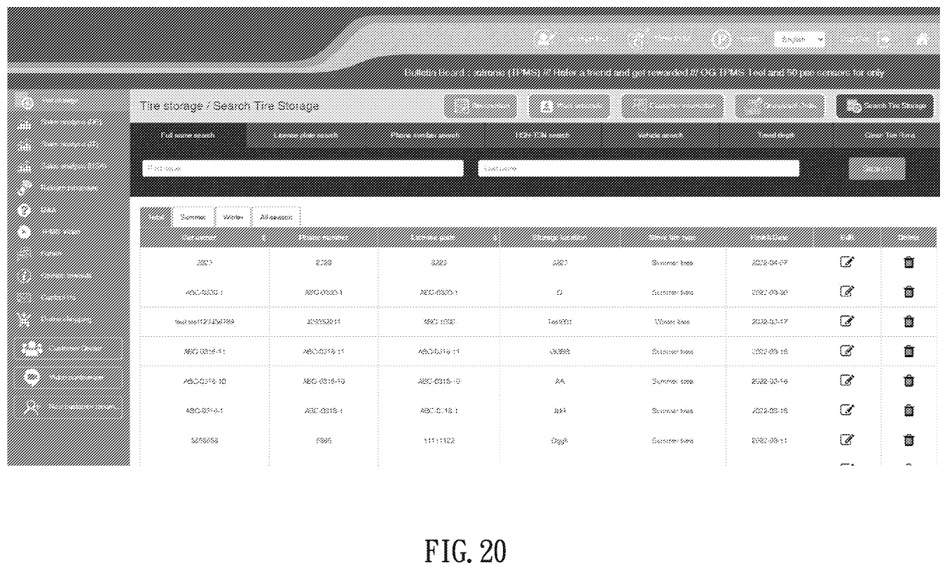

When the customer wants to change tires, the customer information interface is entered, as shown in FIG. 20. A basic information, such as a license plate number, a name of the vehicle owner is inputted. The basic information of the tire is transmitted to the remote server through the application program. The index information including the basic information saved in the remote server is sent to the electronic device. Thus, the storing position of the tire can be gained by searching the index information and is shown on the electronic device. Accordingly, the tires of the customer can be changed. Alternately, the basic information and the position of the tire can be saved in the electronic device, and the storing position of the tire can be gained by directly inputting the basic information into the electronic device.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. A system for setting a storing position of a tire comprising:
a hand held tool for inputting a basic information for the tire and a storing position of the tire in a tire hotel and at least comprising:
a first circuit board; and
a first chip module mounted on the first circuit board and electrically to and controlling a power module, a memory, an operation module, and a network communication module for transmitting the basic information and the storing position of the tire; and
a remote server for receiving the basic information and the storing position of the tire sent from the hand held tool, wherein one of the hand held tool and the remote server generates an index information including the basic information and the storing position of the tire.

2. The system of claim 1 further comprising a TPMS sensor (Tire Pressure Monitoring System Sensor) comprising a storing module and a receiving module electrically connected with the storing module, and the TPMS sensor further comprising a microcontroller module, an electricity module, a transmitting module, and a detecting module, wherein the electricity module, the transmitting module, and the detecting module are electrically connected with the microcontroller module.

3. The system of claim 2 further comprising a radio frequency identification tag (RFID) and a message processing device, wherein the first chip module is connected with and controls an RFID reader and writer that directly read the basic information for the tire stored in the RFID, and the message processing device is capable of sending and receiving information to and from the hand held tool and the remote server.

4. The system of claim 1, wherein the hand held tool further comprises a display module, and one of the display module and the operation module is applied to directly input the basic information for the tire including one of a license plate number, a vehicle identification number (VIN), and a vehicle owner information that is capable of identifying an identification of a vehicle owner.

5. The system of claim 1, wherein the basic information for the tire is stored in a radio frequency identification tag (RFID) attached to the tire or a TPMS sensor, and the hand held tool has a RFID reader and writer that is capable of directly reading the basic information stored in the RFID or the TPMS sensor.

6. The system of claim 5, wherein the hand held tool further comprises a lens module, one of the lens module and the operation module of the hand held tool is applied to input an inputted information including one of an ID of the TPMS sensor, an ID of the FRID, and an identification information of the tire, and RFID reader and writer of the hand held tool is applied to transmit the inputted information to the FRID or the TPMS sensor.

7. The system of claim 1 further comprising a tread depth measuring tool for measuring a tread depth of the tire, or the hand held tool further comprises a lens module for scanning or picturing the tread depth of the tire, wherein the tread depth of the tired being measured, scanned, or pictured is transmitted to the hand held tool and is then transmitted to the remote server from the hand held tool.

8. The system of claim 1, wherein after the basic information is inputted, at least one of a type of tire based on season, identification information of a tire, an ID of a tire, a position of a tire on a vehicle, a storing date and time of a tire, and storing number of tires is inputted into the hand held tool and is sent to the remote server.

9. The system of claim 1, wherein the hand held tool further comprises a lens module for picturing an appearance of the tire after the basic information is inputted, and the appearance of the tire is then sent to the remote server.

10. The system of claim 1 further comprising a computer device connected with the remote server or the hand held tool to access the index information in the remote server or the hand held tool.

11. The system of claim 1 further comprising a TPMS activating device including a second circuit board and a second chip module electrically connected with and controlling a second power module, an operation module, a blue tooth module, a low frequency (125 KHz) transceiver, and a high frequency (315MH/433MH) transceiver, wherein an operational knob is pressed to make the low frequency transceiver send a 125 KHz triggering signal to a TPMS sensor, the high frequency transceiver is capable of receiving a tire pressure signal sent from a TPMS sensor, the tire pressure signal includes an ID number of the TPMS sensor, and the blue tooth module is applied to connect with the hand held tool to transmit the tire pressure signal to the hand held tool.

12. The system of claim 11, wherein the TPMS activating device further comprises a controller area network (CANBUS) module electrically connected with a vehicle computer and transmitting the ID number of the TPMS sensor to the vehicle computer so as to save the ID number of the TPMS sensor in a memory of the vehicle computer or transmit an ID number of a TPMS to the TPMS activating device.

13. The system of claim 11, wherein the first chip module is electrically connected to and controlling a WIFI module, a second blue tooth module, a lens module, a display module, a controller area network module, a USB module, a low frequency (125 KHz) transceiver, a high frequency (315MH/433MH) transceiver, and an RFID reader and writer, the high frequency transceiver is capable of transmitting the index information to the TPMS sensor, and index information is saved in a memory module of the TPMS sensor.

14. The system of claim 13, wherein the first chip module is connected with and controls a buzzer and a vibration motor to generate a sound from the buzzer or a vibration from the vibration motor.

15. The system of claim 1, wherein the first chip module is further connected with and controls a third blue tooth module being capable of transmitting the index information to a TPMS sensor, and index information is saved in a memory module of the TPMS sensor.

16. The system of claim 1, wherein the first chip module is connected with and controls a display module, one of the display module and the operation module is applied to manually input the storing position of the tire in the tire hotel into the hand held tool.

17. A method for setting a storing position of a tire comprising steps of:
inputting a basic information of a tire by a hand held tool;
inputting a storing position of a tire in a tire hotel by the hand held tool; and
transmitting the basic information of the tire and the storing position of the tire to a remote server from the hand held tool, and generating an index information by one of the hand held tool and the remote server.

18. The method of claim 17, wherein the basic information of the tire is stored in a radio frequency identification tag (RFID) attached onto the tire or a TPMS sensor (Tire Pressure Monitoring System Sensor), and the hand held tool has a RFID reader and writer to read the basic information of the tire stored in the RFID or the TPMS sensor for inputting the basic information of the tire into the hand held tool.

19. The method of claim 18, wherein the basic information of the tire includes at least one of a tire manufacture, ID of the tire, model of the tire, size of the tire, and manufacturing date of the tire.

20. The method of claim 18 further comprising steps of:
inputting an inputted information including one of an ID of the TPMS sensor, an ID of the RFID, and an tire identification information into the hand held tool by one of an operation module and a display module of the hand held tool; and
transmitting the inputted information from the hand held tool to the RFID or the TPMS sensor.

21. The method of claim 18 further comprising steps of:
scanning an inputted information including one of an ID of the TPMS sensor, an ID of the RFID, and an tire identification information into the hand held tool by a lens module of the hand held tool; and
transmitting the inputted information from the hand held tool to the RFID or the TPMS sensor.

22. The method of claim 17, wherein in the step of inputting the basic information of the tire, the basic information for the tire including one of a license plate number, a vehicle identification number (VIN), and a vehicle owner information that is capable of identifying an identification of a vehicle owner is directly inputted by one of a display module and an operation module of the hand held tool.

23. The method of claim 17, wherein after the step of inputting the basic information of the tire, at least one of a type of tire based on season, identification information of the tire, an ID of the tire, a position of the tire on a vehicle, and a storing date and time of the tire is inputted into the hand held tool and is sent to the remote server.

24. The method of claim 17 further comprising a step of showing a position of the tire on a vehicle on a display module of the hand held tool and inputting a brand, model, and size of the tire into the hand held tool.

25. An electronic device having a program for setting a storing position of a tire comprising:
providing a selection interface means for providing a selection interface for entering a booking interface, a customer information interface or a tire information searching interface;
inputting basic information means for inputting the basic information of the tire from an inputting interface;
inputting storing position means for inputting a storing position of the tire in a tire hotel from an inputting interface; and
transmitting means for transmitting the basic information of the tire and the storing position of the tire to a remote server.

26. The electronic device of claim 25 further comprising a printing means for selectively printing the basic information of the tire and the storing position of the tire.

27. An electronic device having a program for getting a storing position of a tire comprising:
inputting means for inputting a basic information of the tire and storing the basic information of the tire in a memory of the electronic device; and
transmitting means for transmitting the basic information of the tire to a remote server, wherein an index information including the basic information of the tire is stored in the remote server is transmitted to the electronic device, thereby a storing position of tire in a tire hotel is capable of being get by the index information or directly get from the memory of the electronic device.

28. The electronic device of claim 27, wherein the basic information for the tire including one of a license plate number, a vehicle identification number (VIN), and a vehicle owner information that is capable of identifying an identification of a vehicle owner is directly inputted by the electronic device.

29. A method for searching for a storing position of a tire in a tire hotel comprising steps of:
inputting a basic information of a tire by a hand held tool and transmitting the basic information of the tire to a remote server; and
searching for an index information including a storing position of the tire in a tire hotel corresponding to the sent basic information of the tire, transmitting the index information to the hand held tool, and search and show the storing position of the tire on the hand held tool by using the index information.

30. The method of claim 29, wherein the basic information for the tire including one of a license plate number, a vehicle identification number (VIN), and a vehicle owner information that is capable of identifying an identification of a vehicle owner is directly inputted by the hand held tool.
